(19) United States
(12) Patent Application Publication
(10) Pub. No.: US 2009/0080819 A1
(43) Pub. Date: Mar. 26, 2009

(54) Fluid dynamic bearing having a recirculation channel

(76) Inventor: Thilo Rehm, Villingen-Schwenningen (DE)

Correspondence Address: COOPER & DUNHAM, LLP, 30 Rockefeller Plaza, 20th Floor, NEW YORK, NY, 10112, US

(21) Appl. No.: 12/283,120

(22) Filed: Sep. 9, 2008

(30) Foreign Application Priority Data
Sep. 26, 2007 (DE) 10 2007 046 248.6

(51) Int. Cl. F16C 17/10

(52) U.S. Cl. 384/241

(57) ABSTRACT

The invention relates to a fluid dynamic bearing, particularly for rotatably supporting a spindle motor comprising:
a first bearing part (16) having a substantially cylindrical bore,
a substantially cylindrical second bearing part (20) that is disposed in the bore of the first bearing part (16) and rotatably supported about a rotational axis (50) with respect to the first bearing part, the bearing parts having associated radial bearing faces and axial bearing faces, or tapered bearing faces, a bearing gap (22) filled with bearing fluid that separates the mutually facing surfaces of the two bearing parts (16, 20) from one another and has an open end and a closed end remote from the open end, a sealing gap (40) that is disposed between an outside circumference of the first bearing part (16) and an inside circumference of a part connected to the second bearing part (20) and connected directly or indirectly to the bearing gap (22), a recirculation channel (44) that is disposed in the first bearing part (16) and connects the closed end of the bearing gap (22) directly or indirectly to the open end of the bearing gap, wherein the recirculation channel (44) is connected to the sealing gap (40) at the outside circumference of the first bearing part

### BACKGROUND OF THE INVENTION

The invention relates to a fluid dynamic bearing having a recirculation channel used particularly for the rotatable support of a spindle motor for driving a disk drive.

### PRIOR ART

In recent years, fluid dynamic bearing systems for the rotatable support of spindle motors, as used, for example, for driving disk drives, particularly hard disk drives, have gained increasing acceptance and have replaced the roller bearing systems used previously. A large variety of different designs and constructions for fluid dynamic bearings is known from the prior art.

For example, DE 10 2004 007 557 A1 reveals a fluid dynamic bearing system having a bearing bush and a shaft rotatably supported therein whose bearing surfaces are separated from one another by a bearing gap. The bearing surfaces of the bearing bush and the shaft preferably form two radial bearings. At one end of the shaft, a thrust plate is fixed that, together with the radially oriented surfaces of the bearing bush or a cover plate sealing the bearing, forms two axial bearings. The radial and axial bearings are marked by bearing patterns that, on rotation of the bearing, exert a pumping effect on the bearing fluid and generate corresponding bearing pressure. Owing to the single thrust plate used, this design is also called a single plate design. An equalizing volume or a sealing gap is provided at one open end of the bearing gap, the equalizing volume or sealing gap taking up surplus bearing fluid or preventing bearing fluid from leaking out of the bearing. To allow the circulation of bearing fluid in the bearing gap and to ensure that the bearing is nevertheless closed at one end, a recirculation channel is preferably provided that connects the closed end of the bearing gap to the open end of the bearing gap. The recirculation channel is also there to make it easier for air outgasing from the bearing fluid to escape out of the bearing, which, however, does not always lead to the desired result. In the present embodiment, the bearing fluid flows, for example, from the recirculation channel via a connecting channel back in the direction of the open end of the bearing gap, so that air bubbles that are transported in the recirculation channel are not always reliably transported outwards out of the bearing, but are rather forced back into the bearing gap together with the bearing fluid.

U.S. Pat. No. 7,201,517 B2 reveals another embodiment of a fluid dynamic bearing for rotatably supporting a spindle motor. Particularly in FIGS. 17 and 18, a bearing system is shown that again has a bearing bush and a shaft rotatably supported therein, however, in contrast to the single plate design, it does not have a thrust plate to form axial bearings. This design is rather characterized in that an axial bearing is formed in the region of the open end of the bearing gap between an end face of the bearing bush and a lower face of the rotor (hub), so that this design is also called a top thrust design. Here, a recirculation channel is similarly provided in the bearing bush, which, like the single plate design, allows a circulation of bearing fluid between the closed end of the bearing and the open end of the bearing gap. Again with this bearing design, there remains the problem that air bubbles, which circulate in the bearing fluid, cannot reliably escape from the bearing gap, i.e. from the bearing system, since they are transported back into the bearing gap by the given flow of bearing fluid. To prevent the combination of shaft and hub from falling out of the bearing bush, a stopper ring is disposed on the hub, the stopper ring interacting with a stopper edge disposed on the bearing bush. This system is a wet stopper system, i.e. the stopper edges are flushed with bearing fluid and are located in the region of the sealing gap. On assembly of the bearing, the stopper ring is pressed into an annular member of the hub, which, depending on manufacturing tolerances, could lead to particle abrasion at either the stopper ring or the hub. These abraded particles could get into the bearing fluid since the stopper ring is covered with bearing fluid. For typical bearing gap widths of only a few micrometers, these particles could cause damage to the bearing faces. In a single plate design, the shaft is safeguarded from falling out of the bearing bush by the thrust plate, which is embedded between the bearing bush and the cover plate.

### SUMMARY OF THE INVENTION

It is the object of the invention to provide a fluid dynamic bearing system that, in comparison to well-known bearing constructions, is designed to allow any air bubbles dissolved in the bearing fluid to escape more effectively and reliably out of the bearing fluid to the exterior.

This object has been achieved according to the invention by a fluid dynamic bearing system having the characteristics outlined in claim 1.

Preferred embodiments of the invention and further advantageous characteristics form the subject matter of the subordinate claims.

The fluid dynamic bearing according to the invention has a first bearing part having a substantially cylindrical bore, a substantially cylindrical second bearing part that is disposed in the bore of the first bearing part and rotatably supported about a rotational axis with respect to the first bearing part, the bearing parts having associated radial bearing faces and axial bearing faces, or tapered bearing faces, a bearing gap filled with bearing fluid that separates the facing surfaces of the two bearing parts from one another, and an open end and a closed end remote from the open end, a sealing gap that is disposed between an outside circumference of the first bearing part and an inside circumference of a part connected to the second bearing part and connected directly or indirectly to the bearing gap, and a recirculation channel that is disposed in the first bearing part and connects the closed end of the bearing gap directly or indirectly to the open end of the bearing gap.

The important characteristic of the invention is that the recirculation channel is connected to the sealing gap at the outside circumference of the first bearing part.

In particular, it can be provided for one end of the recirculation channel to penetrate the outside circumference of the first bearing part in the region of the sealing gap.

The advantage of this design for the recirculation channel is that the recirculation channel leads directly into the region of the sealing gap, to be precise in the vicinity of the boundary line between the bearing fluid and the atmosphere, so that, once they enter the sealing gap, any air bubbles transported in the recirculation channel in the direction of the sealing gap, can escape relatively easily into the atmosphere before the bearing fluid is again transported from the sealing gap into the bearing gap and from there flows to the other end of the bearing and back into the recirculation channel. One opening in the recirculation channel leads accordingly to the outside diameter of the first bearing part, i.e. of the bearing bush, whereas the other opening in the recirculation channel is disposed in the end face of the first bearing part, to be precise, at the closed end of the bearing gap.

According to an embodiment of the invention, the recirculation channel may be made up of a single channel extending obliquely to the rotational axis, the channel being formed, for example, as a single hole whose bore penetrates the outside circumference of the first bearing part, such as a bearing bush, in the region of the sealing gap. This means that the first bearing part is not bored right through, as is the case in the prior art, but rather that the recirculation channel leads into the sealing gap beforehand at the outside diameter of the first bearing part.

According to a further embodiment of the invention, it can be provided that the recirculation channel is made of a single channel extending obliquely to the rotational axis that extends right through the first bearing part and connects the end faces of the first bearing part, or the gaps adjoining the end faces, to one another. This channel additionally penetrates the bearing bush at its outside diameter in the region of the sealing gap. The recirculation channel accordingly has three openings through which it merges into corresponding gaps or gap regions as well as the sealing gap. This results in a very regular circulation of bearing fluid, wherein, in particular, any air bubbles dissolved in the bearing fluid may reliably escape via the sealing gap into the atmosphere.

In another embodiment of the invention, the recirculation channel may be made up of a section extending substantially parallel to the rotational axis and a section extending substantially perpendicular to it, the opening of the perpendicular section leading into the sealing gap, while the opening of the axial section leads into the opposing end face of the first bearing part.

In a fourth embodiment of the invention, a first section of the recirculation channel may extend substantially obliquely to the rotational axis and merge into a section extending perpendicularly to the rotational axis.

In the last two cases, the recirculation channel is thus formed as an axial or oblique blind bore that is connected via a transversal bore to the sealing gap.

It is important that the recirculation channel extends only over a part of the axial length of the first bearing part, i.e. of the bearing bush.

The opposing axial faces of the first bearing part (bearing bush) and the second bearing part (shaft) form one or two radial bearings in that they are provided with appropriate bearing patterns.

Depending on the embodiment of the bearing, as a single plate design, for example, or perhaps as a top thrust design, an axial bearing may be formed, for example, by the mutually facing bearing faces of the first bearing part and of a rotor part connected to the second bearing part, these bearing faces being separated from one another by the bearing gap.

The axial bearing may, however, be formed by the mutually facing bearing faces of a thrust plate disposed on the shaft at the closed end of the bearing and the associated bearing faces of the first bearing part and/or a cover plate sealing the bearing. Further, it is possible to form the shaft and the thrust plate from one piece.

The problem of undesirable particles being formed during the pressing in of the stopper ring is solved by the annular part that forms a face of the sealing gap and has an inside circumference that is connected to an outside circumference of an annular shoulder of a rotor part connected to the second bearing part. This means that particle abrasion can now only take place outside the sealing gap.

The described fluid dynamic bearing is suitable for rotatably supporting a spindle motor as utilized, for example, in a hard disk drive.

Preferred embodiments of the invention are described in more detail below on the basis of the drawings. Further characteristics and advantages of the invention can be derived from the drawings and their description.

### BRIEF DESCRIPTION OF THE DRAWINGS

FIG. 1 shows a first embodiment of the fluid dynamic bearing according to the invention having a single obliquely extending recirculation bore.

FIG. 2 shows a second embodiment of the fluid dynamic bearing according to the invention having a recirculation channel made up of a longitudinal bore and a transversal bore.

FIG. 3 shows a third embodiment of the fluid dynamic bearing according to the invention having an obliquely extending recirculation bore that is connected via a transversal bore to the sealing gap.

FIG. 4 shows a fourth embodiment of the fluid dynamic bearing according to the invention having a single obliquely extending recirculation bore.

FIG. 5 shows an embodiment of a fluid dynamic bearing having a single obliquely extending recirculation bore that is not connected to the outside circumference of the first bearing part.

### DETAILED DESCRIPTION OF PREFERRED EMBODIMENTS OF THE INVENTION

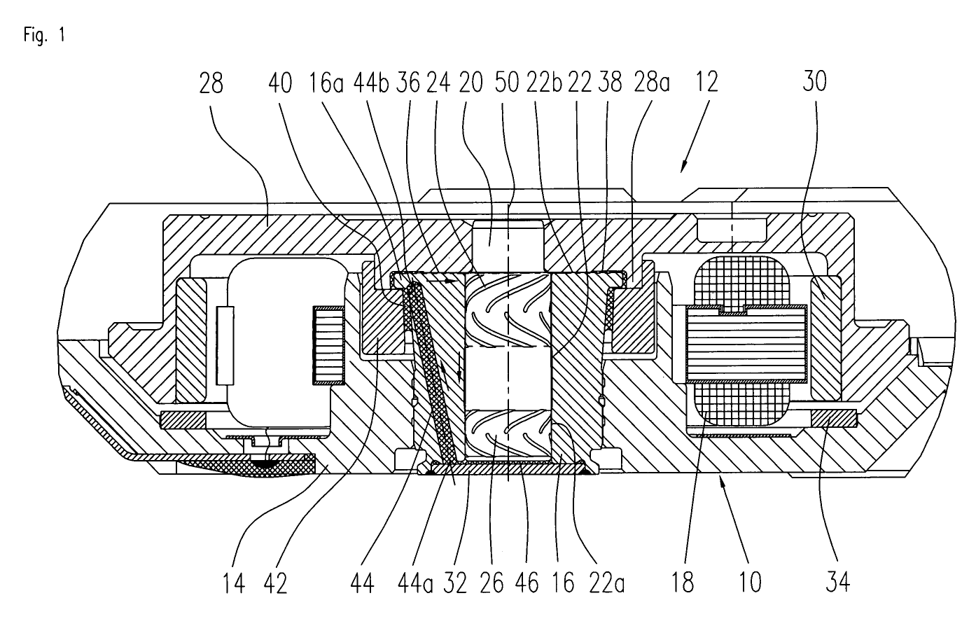

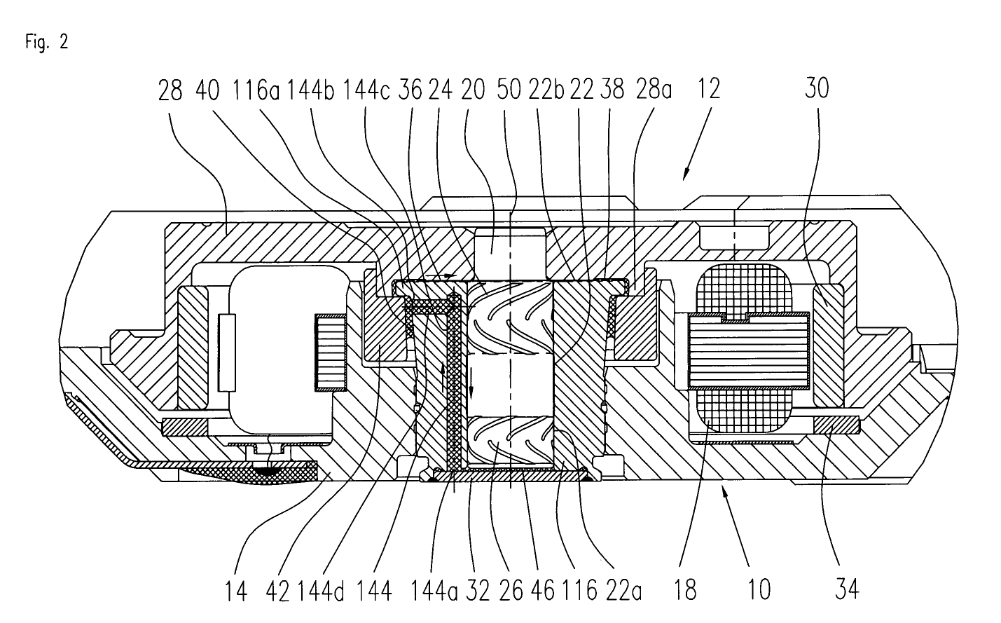

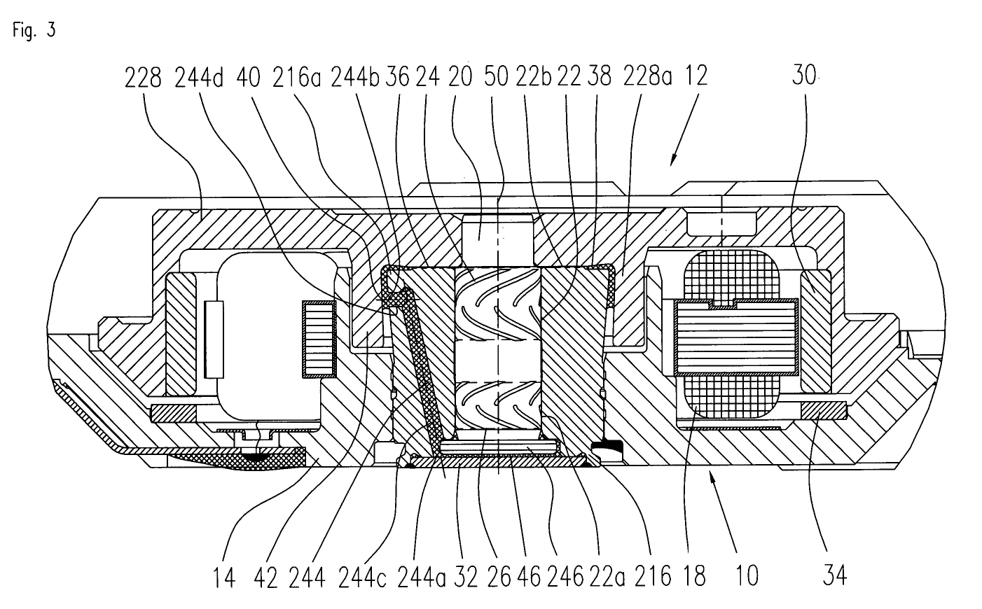

The construction of the fluid dynamic bearing system according to the invention or a spindle motor rotatably supported by means of the bearing system is substantially identical in the embodiments according to FIGS. 1 to 3. Hence, the construction of the bearing system and of the associated spindle motor will only be described in detail in FIG. 1, the description also applying to FIGS. 2 and 3 to the extent that they refer to the same parts having the same reference numbers.

A spindle motor having a first embodiment of the fluid dynamic bearing system according to the invention is shown in FIG. 1. The spindle motor comprises a stationary motor arrangement 10 and a rotating motor arrangement 12 that is rotatably supported with respect to the stationary arrangement by means of the bearing system. The stationary arrangement 10 comprises a baseplate 14 on which the rest of the motor components are fixed. The baseplate 14 comprises a central sleeve-shaped part having a central bore in which a substantially hollow cylindrical bearing bush 16 is fixed, by means, for example, of pressing, bonding or welding. The baseplate 14 may be made, for example, of a light metal such as aluminum, whereas the bearing bush may be made of a large variety of metals or ceramics. A stator arrangement 18 is fixed to the sleeve-shaped portion of the baseplate 14 and forms part of an electromagnetic drive system of the spindle motor. The stator arrangement 18 consists of a magnetic core as well as appropriate phase windings. A shaft 20 made, for example, of steel is rotatably disposed in the bore of the bearing bush 16, rotatable about a rotational axis 50. The shaft 20 has a slightly smaller diameter than the bore in the bearing bush 16, so that a bearing gap 22 remains between the shaft 20 and the bearing bush 16. Two fluid dynamic radial bearings 24 and 26 are disposed in an axial section 22a of the bearing gap 22 at a mutual spacing, the fluid dynamic radial bearings being marked by appropriate surface patterns on the surface of the bore of the bearing bush 16 or on the circumferential surface of the shaft 20. When the shaft 20 rotates in the bearing bush 16, these surface patterns generate a pumping effect in the bearing fluid, such as a bearing oil, by means of which hydrodynamic pressure is built up in the bearing gap 22, thus giving the bearing 24, 26 its load-carrying capacity. The radial bearings 24, 26 preferably have a pumping effect in a specific axial direction, preferably in the direction of the closed end of the bearing that is sealed by a cover plate 32 which is fixed in a recess of the bearing bush 16 and hermetically seals the bearing bush.

A free end of the shaft 20 that projects beyond the bore of the bearing bush 16 is connected to a hub 28, which has a substantially cup-shaped cross-section and partly encloses the bearing system and the stator arrangement. The hub 28 is pressed, for example, onto the free end of the shaft 20. Alternatively, the shaft and the hub may be formed from one piece. The hub 28 has an approximately cylindrical circumferential rim on whose inside diameter a magnet 30 is fixed, the magnet completing the stator arrangement 18 and together with the stator arrangement, forming the electromagnetic drive system. If the spindle motor is used for driving a disk drive, then one or more storage disks, for example, are also fixed onto the hub 28. A metal plate 34 located opposite the magnet 30 in an axial direction is provided, the metal plate attracting the magnet 30 and stabilizing the hub 28 in an axial direction.

As mentioned previously, the open end of the bearing bush 16 is sealed by the cover plate 32, a gap 46 filled with bearing fluid remaining between the end of the shaft 20 and the cover plate 32.

The upper end face of the bearing bush 16 that is adjacent to the hub 28 is formed as a bearing face, as is the adjacent face of the hub 28 as well. The two bearing faces of the bearing bush 16 and the hub 28 form an axial bearing 36 that, like the radial bearings 24, 26, is also marked by bearing patterns that are disposed on the surface of the bearing bush 16 and/or the surface of the hub 28. This axial bearing 36 is formed in a radially extending section 22b of the bearing gap 22 that adjoins the axially extending section 22a of the bearing gap. The axial bearing 36 comprises, for example, spiral-shaped or herringbone patterns that generate a pumping effect directed in the direction of section 22a of the bearing gap and force the bearing fluid into the interior of the bearing gap 22. Radially outwards of the axial bearing 36, the bearing gap 22 widens into a gap 38 that now bends and leads into an axially extending sealing gap 40 that is designed as a capillary seal, particularly a tapered capillary seal. The sealing gap 40 is defined by an outer surface of the bearing bush 16 and an opposing annular surface of an annular part 42 that simultaneously functions as a stopper ring. The surfaces of the bearing bush 16 and the stopper ring 42 defining the sealing gap 40 may, for example, extend parallel to the rotational axis 50, although it is preferable if they are slightly inclined with respect to the rotational axis 50 and inclined in such a way that the inside diameter of the stopper ring 42 decreases in the direction of the opening of the sealing gap 40 to a lesser extent than the outside diameter of the bearing bush 16, thus producing a substantially tapered cross-section of the sealing gap 40. The annular part 42 is fixed on an annular shoulder of the hub 28 and lies opposite a stopper flange 16a of the bearing bush 16 and, together with the stopper flange, prevents the arrangement of hub and shaft from falling out of the bearing bush. Here, the stopper flange 16a is disposed opposite the shoulder 28a of the hub 28, and the annular part 42 is connected at its inside diameter to the outside diameter of the shoulder 28a.

According to the invention, a recirculation channel 44 is provided that connects the closed end of the bearing, i.e. the region of the gap 46, to the open end of the bearing via the sealing gap 40. According to FIG. 1, the recirculation channel 44 is designed as an oblique blind bore, one opening 44a of which leads into channel 46 and the other opening 44b penetrates the outside circumference of the bearing bush 16 in the region of the sealing gap 40. Since the second opening 44b of the recirculation channel is disposed very close to the transition zone between the bearing fluid and the atmosphere, any air bubbles dissolved in the bearing fluid can escape relatively easily into the atmosphere, considerably easier at least than if the recirculation channel were to lead into section 22b of the bearing gap 22, where the air bubbles in the bearing fluid would be re-pumped, together with the bearing fluid, into the bearing by the pumping effect of the axial bearing 36. The circulation of the bearing fluid is indicated by the arrow located next to the bearing gap 22 or the recirculation channel 44 respectively.

FIG. 2 shows a second embodiment of the bearing system according to the invention in which the only difference to FIG. 1 lies in the design of the recirculation channel 144. The recirculation channel 144 again begins at the end face of the bearing bush 116 in the region of the gap 46 that is formed between the end face of the shaft 20 and the cover plate 32. A first section of the recirculation channel 144c is formed as a blind bore running parallel to the rotational axis 50, which does not penetrate right through the axial length of the bearing bush 16. In the region of the sealing gap 40, a transversal bore taking the form of a radial section 144d of the recirculation channel is provided in the bearing bush 116, this radial section merging into the axial section 144c. In contrast to FIG. 1 and recirculation channel 44, two processing steps are needed to manufacture recirculation channel 144, to form the first longitudinal bore and the transversal bore.

Common to the two embodiments in FIGS. 1 and 2, is that an annular part 42 is used as a stopper element. The annular part 42 is fixed to an annular shoulder 28a of the hub 28 in such a way that a shoulder of the part 42 encloses a shoulder 28a of the hub 28. This means that the annular part 42 is fixed at the outside diameter of the shoulder 28a of the hub and is seated on the end face of the shoulder of the hub. The part 42 may be fixed, for example, to the shoulder of the hub 28 by an interference fit or also by bonding or welding. In particular, this method of fixing the part has advantages over the prior art described earlier since no particle abrasion that could get into the bearing fluid is created when the part 42 is pressed onto the shoulder 28a of the hub 28 in the region of the sealing gap 40. At the most, particle abrasion could occur at the outside diameter of the shoulder 28a of the hub which, however, holds no risk for the function of the bearing system. Thus fixing the annular part 42 according to the present invention is advantageous compared to the known prior art.

FIG. 3 shows a further modified embodiment of the fluid dynamic bearing system according to the invention, the recirculation channel 244 here having a first section 244c extending obliquely to the rotational axis 50 that is connected via a second section 244d, which runs as a transversal bore in a radial direction, to the sealing gap 40. The spindle motor according to FIG. 3 no longer has a stopper ring 42 as in the embodiments according to FIG. 1 and FIG. 2. Instead, the annular shoulder 228a of the hub 228 is much more pronounced and, instead of the stopper ring, now forms a periphery of the sealing gap 40, whereas the other periphery of the sealing gap 40 is still formed by the outside circumference of the bearing bush 16. The peripheries of the sealing gap 40 may either be formed parallel to the rotational axis 50 or inclined at a slight slant to the rotational axis 50, at an angle, for example, of between 3° and 8°. The sealing gap 40 preferably widens in the direction of its opening, thus forming a tapered capillary seal whose cross-section is conical.

As a safeguard against the shaft 20 falling out of the bearing bush 216, a stopper element is provided in the embodiment according to FIG. 3, the stopper element being provided at the end of the shaft 20 that is located in the bearing bush 216. This stopper element consists of a stopper plate 246 that is embedded in a recess of the bearing bush 216 and whose diameter is larger than the diameter of the shaft 20. This stopper ring 246 is thus enclosed in the recess between the radially extending faces of the bearing bush 216 and the cover plate 32, a gap 46 remaining between the cover plate 32 and the stopper plate 246 which is used to establish a connection between the axial section 22a of the bearing gap 22 and the recirculation channel 244. The stopper plate 246 has two end faces, a circular end face disposed opposite the cover plate 32 and an annular end face disposed opposite an annular face of the bearing bush 216. Both these end faces may be provided with bearing patterns, so that they form axial bearings with the opposing end faces of the bearing bush 216 or the cover plate 32 accordingly.

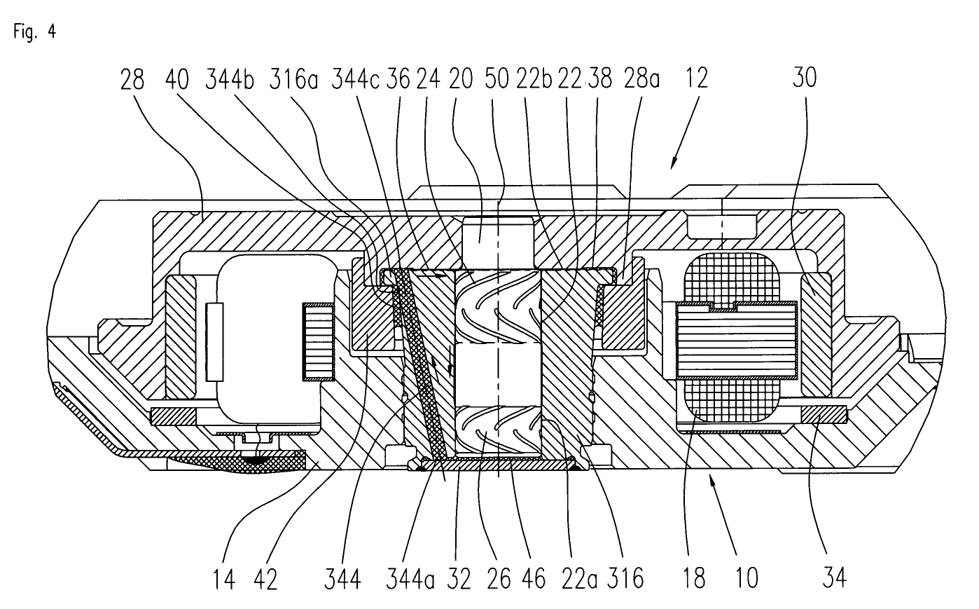

In FIG. 4, a fluid dynamic bearing system for a spindle motor is shown which substantially corresponds to the bearing system or spindle motor shown in FIG. 1. Identical parts or parts having the same functions are indicated by the same reference numbers. The recirculation channel 344 is formed as an oblique bore that extends right through the bearing bush 316 and connects the two end faces of the bearing bush to one another. A first opening 344a of the recirculation channel 344 leads into a channel 46 at the closed end of the bearing, and a second opening 344b of the recirculation channel penetrates the outside circumference of the bearing bush 16 in the region of the sealing gap 40. A third opening 344c of the recirculation channel leads radially outwards of the upper axial bearing in the transition region of the radial section 22b of the bearing gap 22 and the widened gap 38. In this way, the bearing fluid can get from the lower gap 46 via the recirculation channel 344 into the sealing gap 40 and at the same time into the region of the opening 344c, where, through the pumping effect of the upper axial bearing, it is again transported back into the bearing gap.

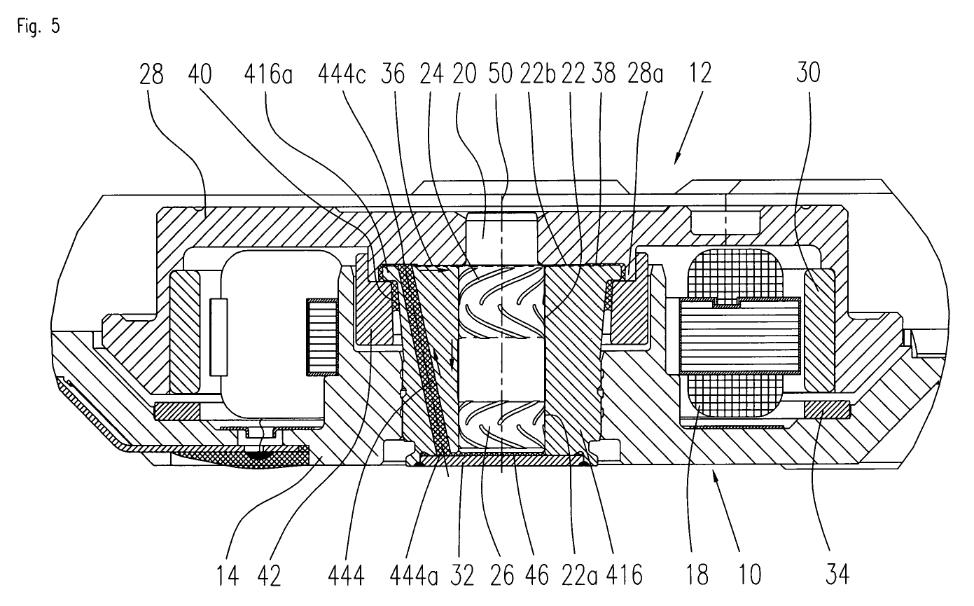

FIG. 5 shows a further embodiment of a fluid dynamic bearing system that largely corresponds to the bearing system according to FIG. 1 or FIG. 4. In FIG. 5, identical parts are indicated by the same reference numbers as used in FIG. 1. A recirculation channel 444 that again extends right through the bearing bush 416 is provided, one opening 444a of which leads into the gap 46 at the closed end of the bearing, and whose other opening 444c leads into the transition region between the bearing gap 22b and the widened gap 38. Provision is not made here for the recirculation channel 444 to penetrate the outside diameter of the bearing bush 416 in the region of the sealing gap 40, but this could be realized by a transversal bore in the bearing bush 416 at the level of the sealing gap 40.

As in FIG. 1, an annular part 42 is again provided in FIG. 5 as a stopper element, which lies adjacent to the sealing gap 40 and at the same time forms part of a wet stopper system. The annular part 42 has a stepped shoulder whose inside circumference encloses the outside circumference of an annular shoulder 28a of the hub 28. The annular part 42 and its attachment to the hub 28 have been described earlier in conjunction with the embodiments of FIGS. 1 and 2. This description applies equally to FIG. 5.

### Identification Reference List

10 Stationary arrangement
12 Rotating arrangement
14 Baseplate
16 Bearing bush
16a Stopper flange
18 Stator arrangement
20 Shaft
22 Bearing gap
22a Section of the bearing gap
22b Section of the bearing gap
24 Radial bearing
26 Radial bearing
28 Hub
28a Shoulder
30 Magnet
32 Cover plate
34 Metal plate
36 Axial bearings
38 Gap (widened)
40 Sealing gap
42 Annular part (stopper)
44 Recirculation channel
44a Opening
44b Opening
46 Gap (cover plate)
50 Rotational axis
116 Bearing bush
116a Stopper flange
144 Recirculation channel
144a Opening
144b Opening
144c Section
144d Section
216 Bearing bush
216a Stopper flange
228 Hub
228a Shoulder
244 Recirculation channel
244a Opening
244b Opening
244c Section
244d Section
246 Stopper plate
316 Bearing bush
316a Stopper flange
344 Recirculation channel
344a Opening
344b Opening
344c Opening
416 Bearing bush
416a Stopper flange
444 Recirculation channel
444a Opening
444c Opening

1. A fluid dynamic bearing used particularly for rotatably supporting a spindle motor comprising:
a first bearing part having a substantially cylindrical bore,
a substantially cylindrical second bearing part that is disposed in the bore of the first bearing part and rotatably supported about a rotational axis with respect to the first bearing part, the bearing parts having associated radial bearing faces and axial bearing faces, or tapered bearing faces,
a bearing gap filled with bearing fluid that separates the mutually facing surfaces of the two bearing parts from one another and has an open end and a closed end remote from the open end,
a sealing gap that is disposed between an outside circumference of the first bearing part and an inside circumference of a part connected to the second bearing part (20) and connected directly or indirectly to the bearing gap (22),
a recirculation channel that is disposed in the first bearing part and connects the closed end of the bearing gap directly or indirectly to the open end of the beaming gap,
characterized in that,
the recirculation channel is connected to the sealing gap at the outside circumference of the first bearing part.

2. A fluid dynamic bearing according to claim 1, characterized in that one end of the recirculation channel penetrates the outside circumference of the first bearing part in the region of the sealing gap.

3. A fluid dynamic bearing according to claim 1, characterized in that another end of the recirculation channel penetrates through an end face of the first bearing part.

4. A fluid dynamic bearing according to claim 1, characterized in that the recirculation channel consists of a single channel extending obliquely to the rotational axis.

5. A fluid dynamic bearing according to claim 4, characterized in that t he recirculation channel is formed as a single bore that penetrates the outside circumference of the first bearing part.

6. A fluid dynamic bearing according to claim 4, characterized in that t he recirculation channel is formed as a single bore that penetrates the outside circumference of the first bearing part and at the same time connects the two end faces of the first bearing part to each other.

7. A fluid dynamic bearing according to claim 1, characterized in that the recirculation channel comprises a section extending substantially parallel to the rotational axis and a section extending substantially perpendicular to it.

8. A fluid dynamic bearing according to claim 3, characterized in that the recirculation channel comprises a section extending substantially obliquely to the rotational axis and a section extending substantially perpendicular to the rotational axis.

9. A fluid dynamic bearing according to claim 7, characterized in that the recirculation channel is formed as a blind bore that is connected via a transversal bore to the sealing gap.

10. A fluid dynamic bearing according to claim 1, characterized in that the recirculation channel extends only over a part of the axial length of the first bearing part.

11. A fluid dynamic bearing according to claim 1, characterized in that an axial bearing is formed by the mutually facing bearing faces of the first bearing part and a rotor part connected to the second bearing part, these bearing faces being separated from one another by a radially extending section of the bearing gap.

12. A fluid dynamic bearing according to claim 1, characterized in that an axial bearing is formed by a thrust plate disposed on the shaft at the closed end of the bearing and the associated bearing faces of the first bearing part and/or a cover plate (32) sealing the bearing.

13. A fluid dynamic bearing according to claim 1, characterized in that the part connected to the second bearing part is an annular part and has an inside circumference that is connected to an outside circumference of an annular shoulder of a rotor part connected to the second bearing part.

14. A fluid dynamic bearing according to claim 13, characterized in that the inside circumference of the annular part together with the outside circumference of the first bearing part forms a tapered capillary seal.

15. A fluid dynamic bearing according to claim 1, characterized in that it is used for rotatably supporting a spindle motor.

16. A fluid dynamic bearing according to claim 1, characterized in that it is used for rotatably supporting a spindle motor for deployment in a hard disk drive.
